(19) United States
(12) Patent Application Publication
(10) Pub. No.: US 2022/0286081 A1
(43) Pub. Date: Sep. 8, 2022

(54) PV-CHIMNEY

(71) Applicant: Pholtaire B.V., Rotterdam (NL)

(72) Inventors: Zoheir HAGHIGHI, Rotterdam (NL); Juan Camilo ORTIZ LIZCANO, Rotterdam (NL); Olindo ISABELLA, Rotterdam (NL); Miroslav ZEMAN, Rotterdam (NL); Andrew VAN DEN DOBBELSTEEN, Rotterdam (NL)

(73) Assignee: Pholtaire B.V., Rotterdam (NL)

(21) Appl. No.: 17/625,588

(22) PCT Filed: Jun. 26, 2020
(86) PCT No.: PCT/NL2020/050422

§ 371 Date: Jan. 7, 2022

(30) Foreign Application Priority Data
Jul. 8, 2019 (NL) 2023454

(51) Int. Cl. H02S 20/26; H02S 40/44; F24S 20/66; F24S 20/61; F24F 5/00

(52) U.S. Cl. CPC H02S 20/26; H02S 40/44; F24S 20/66; F24S 20/61; F24F 5/0046; F24F 2005/0067

(57) ABSTRACT

The present invention is in the field of an improved naturally ventilated façade with incorporated PV that can provide heating and ventilation and can provide electricity. Especially for buildings receiving high amounts of sunshine and in particular when such buildings need ventilation such systems can be applied advantageously.

### FIELD OF THE INVENTION

The present invention is in the field of an improved naturally ventilated façade with incorporated PV that can provide heating and ventilation and can provide electricity. Especially for buildings receiving high amounts of sunshine and in particular when such buildings need ventilation such systems can be applied advantageously.

### BACKGROUND OF THE INVENTION

The present invention is in the field of an improved building integrated photo-voltaic system that can provide heating and ventilation and can provide electricity. Building integrated photo-voltaic (BIPV) systems have been applied to some extent recently. These systems can be used to replace conventional building materials in parts of the building envelope such as the roof, skylights, and facades. However, the economic benefit has only been reached recently. They are therefore more and more incorporated into construction of old or new buildings as a source of electrical power and either placed on the wall of such buildings or on an outer glass panel. In an alternative the system may be used as blinds, such as on blind slats. However performance of such systems is hampered by heating of the PV-cells. Further power consumption of a building may be reduced by providing a so-called Trombe wall. A Trombe wall is a passive design, typically on a winter sun side of a building, provided with a glass external layer and a high heat capacity internal layer separated by a layer of air. Light may be absorbed by the wall and heating an inside of the building. Trombe walls may be used to absorb heat during sunlit hours of winter then slowly release the heat over night. Trombe walls may be constructed with or without internal vents. Vented Trombe walls may use flaps for directing air flow. Vented and non-vented walls offer both certain advantages, and it is therefore not clear which of the two is more advantageous. So studies conducted on naturally ventilated façades are not in agreement with one and another and the thermal benefit of such a design is debated among scientists. Some background art may be referred to. U.S. Pat. No. 6,912,816 B2 recites a structurally integrated solar collector. Roof and wall covering components are integrated with solar collectors to permit solar energy to be converted to heat, electricity and hot water for use within a building. A roof truss is described that additionally captures sunlight for illuminating a building. The roof and wall components are adaptable to heating and cooling seasons so as to minimize the loss of air-conditioned air in the summer time and to maximize solar heating during cold months. Solar energy captured by a structurally integrated solar collector can be directly converted to electricity through use of photovoltaic materials or by harnessing airflow through structurally integrated solar collector to obtain electricity through mechanical conversion. EP 3 182 580 A1 recites a photovoltaic module for ventilated facade, comprising a photovoltaic panel composed of a front rectangular glass pane, a rear rectangular glass pane, laminating films adhering to said panes, and a set of photovoltaic cells disposed between said panes and films, said cells arranged in rows parallel to each other and separated from each other by conductive tracks, whereas all the panel components are laminated together to form a monolith equipped with junction boxes for solar leads and connectors the essential idea of which consists in that the rear glass pane of the photovoltaic panel is joined permanently with flanges of vertically oriented of load-bearing sections aluminium T-sections, webs of which are provided with profiled hooks on their ends, and moreover, flange of membrane resting on horizontal flange of metal equal-leg angle is adjacent to the lower side of the rear glass pane and the rear glass pane of the panel, said panes being laminated together. US 2013/041515 A1 recites a power generating system for a building is provided, the building has a wall structure and a curtain wall covering the wall structure. The power generating system includes an energy conversion module, a detecting module, a control module and a regulating module. The energy conversion module is integrated with the curtain wall for generating a first electrical power. DE 101 44 148 A1 recites a solar energy device comprises a photovoltaic solar module arranged on the side of the building facing the sun; a heat exchanger connected to the module via lines; and a control and regulating device. The solar module has flexible foil-like elements lying singly or together on an amorphous, metallic or metal-coated substrate and embedded in the roof or facade of the building. Solar energy device comprises a photovoltaic solar module (1) arranged on the side of the building facing the sun; a heat exchanger connected to the module via lines; and a control and regulating device. The solar module has flexible foil-like elements lying singly or together on an amorphous, metallic or metal-coated substrate and embedded in the roof or facade of the building. Each element has air channels arranged on the lower side of the substrate through which air flows to be heated or to cool the solar module. The heated air is fed to the heat exchanger which is connected to a heat pump having an earth collector or probe. The heated air post-heated by the heat pump and/or damper register is distributed into the individual rooms via a ventilation system. It is noted that PV-panels applied at an exterior of a building, such as a roof, are typically considered not very aesthetic. In addition PV-modules get polluted, and cleaning of the PV-modules is somewhat cumbersome.

The present invention therefore relates to an improved naturally ventilated façade with photovoltaic modules which solve one or more of the above problems and drawbacks of the prior art, providing reliable results, without jeopardizing functionality and advantages.

### SUMMARY OF THE INVENTION

The present invention relates to modular structure 100 for attaching to a wall, such as a façade. The modular structure may be applied to existing buildings, or may be applied (an integrated) to new buildings. The modular structure may be applied to part of a building, or to a full façade of a building. Typically the structure is place in a vertical position, that is an angle w.r.t. earth surface is 90, but likewise the structure could be at least partly tilted, such as following a contour of a building, or even of a roof. The structure comprises and encloses at least one PV-module 1 attached to at least one spacer, the spacer providing a distance of >5 cm of the PV-module from the wall, such as a distance of >10 cm, such as 15-40 cm, e.g. 20-30 cm. The PV-module comprises an array of at least 2*2 cells, typically n*m cells, wherein n∈[2,210], preferably n∈[3,28], more preferably n∈[4,26], such as n∈[6,26], and wherein m∈[2,210], preferably m∈[3,28], more preferably m∈[4,26], such as m∈[6,26], such as an array with [24,256] cells, such as [32,128] cells. For natural ventilation of the wall (or façade, NVF) the modular structure comprises at least one duct 4 at least partly enclosing the at least one PV-module, the duct providing a distance of >5 cm of the front-side of the PV-module, the duct preferably having a depth of at least two times of the distance of the PV-module to the wall. In other words a “cavity” or air flow channel at a front side of the PV-module and a “cavity” or air flow channel at a backside of the PV-module is provided, the cavities providing a duct for air flow. The NVF removes indoor air from the indoor environment, requiring additional air inlets elsewhere in the building, the NVF acts as a buffer with convective air movement only within the channel, the NVF channel is ventilated by outdoor air with no connection to the indoor air, and the NVF channel is ventilated by indoor air with no connection to the outdoor air. The structure comprises optionally a back layer comprising an insulating material. Further it comprises at least one adaptable inlet 2, wherein at least one inlet is located at the bottom part of the duct 4, at least one adaptable outlet 3, located at the top part of the duct or in an outside of the duct, wherein the inlet and outlet are in fluid connection with at least one duct, wherein the vertical structure is adapted to provide a convective air flow over the PV-module and through the duct and inlet and outlet, and a controller for opening and closing the at least one adaptable inlet and at least one adaptable outlet. The at least one inlet may be venturi shaped, in order to accelerate the incoming air flow, and/or the at least one outlet may be venturi shaped, in order to accelerate the outgoing air flow. Therewith good control over air flows is provided, good ventilation, and ventilation to the at least one PV-module. By ventilating the building or PV-module cooling is provided.

In a second aspect the present invention relates to a method of operating a modular vertical structure according to the invention, comprising providing said vertical structure, converting light into electricity, providing a passive convective air flow over the PV-module and through the duct and inlet and outlet, optionally stripping heat from the air flow, optionally providing heating, ventilation, or air conditioning, or a combination thereof, and optionally at least partly opening or closing at least one duct, opening, inlet, and outlet. It is preferred to have a thermal entrance length being <0.5 time a modular channel length, preferably <0.1 said length. It is found that especially the heat flow is increased compared to placing PV-modules either at the inner façade or at the outer side of the duct.

Thereby the present invention provides a solution to one or more of the above mentioned problems and drawbacks. Advantages of the present description are detailed throughout the description.

### DETAILED DESCRIPTION OF THE INVENTION

The present invention relates in a first aspect to modular structure according to claim 1.

In an exemplary embodiment of the present structure the structure provides passive Heating, passive ventilation, and passive air conditioning (HVAC).

In an exemplary embodiment of the present structure the at least one inlet and/or at least one outlet comprise a closure 8.

In an exemplary embodiment of the present structure the at least one inlet 2 is adapted to be in fluid contact with a at least one opening 11 provided in a building wall, at an inside of the duct, preferably wherein at least one inlet 2 per story is provided.

In an exemplary embodiment of the present structure at least part of the vertical structure is transparent such as the front side of the duct, and optionally at least one side of the duct.

In an exemplary embodiment of the present structure the at least one inlet and/or at least one outlet comprise a variable opening.

In an exemplary embodiment the present structure may comprise at least one fastener for attaching to the wall (of a building).

In an exemplary embodiment the present structure may comprise a heat exchanger for stripping heat from the air flow, or a heat absorber 9, a phase change material, or a heat storage, or a combination thereof, preferably located at a back of the at least one PV-module. In an example thereof at least one PV-module may be provided with tubes for passing through a fluid, such as water. The fluid further cools the PV-panel. The obtained heat may be used for heating the building.

In an exemplary embodiment of the present structure a cross-sectional shape of the duct is selected from triangular, hexangular, square, rectangular, oval, circular, and combinations thereof.

In an exemplary embodiment of the present structure the duct is made of glass, an optical converter, a Fresnel lens, a gradient index lens, an axicon, a diffractive material, a parabolic concentrator, a reflector, and combinations, preferably such that over a day light yield on the PV-module is increased.

In an exemplary embodiment of the present structure the PV-module comprises solar cells selected from interdigitated back contact solar cells, thin film solar cells, silicon based solar cells, such as crystalline and amorphous silicon solar cells, Copper Indium Gallium Selenide thin film cells, and combinations thereof.

In an exemplary embodiment of the present structure the duct comprises an inlet at a base area thereof.

In an exemplary embodiment of the present structure the duct has a height of >1 m, a depth of >20 cm, and a width of >20 cm, preferably a depth of 20-30 cm, preferably a width of >100 cm, and wherein the height:width is from 4:1 to 1:1, preferably 3:1 to 1.5:1.

In an exemplary embodiment of the present structure the convective air flow is a passive convective air flow.

In an exemplary embodiment of the present structure the at least one PV-module is located at >5 cm from a back from the structure, preferably at 10-20 cm from the back.

In an exemplary embodiment of the present method the vertical structure is provided below a roof line.

The present invention has also been subject of a theses by S. H. Wapperom entitled “The energetic performance of a naturally ventilated façade with photovoltaic modules placed as outer façade or at various depths in the air channel” which document and its contents are incorporated by reference.

The one or more of the above examples and embodiments may be combined, falling within the scope of the invention.

### EXAMPLES

The below relates to examples, which are not limiting in nature.

The models used in the research have been validated by experiments (see FIG. 3). The geometric identification of space (left, right, top, bottom, back, front, width, height and depth) will be used throughout the text. The shades placed above and below the first layer are not shown in the render. The resulting height to width ratio is roughly 0.5. A glass-glass PV module of 8 mm thickness is used as front or middle layer, a hardened glass sheet of 8 mm thickness is used as front layer and the back layer is insulated with 60 mm thick polystyrene encapsulated in two 18 mm thick plates of MDF. The materials of the frame are chosen as wood, its low conductivity ensures minimal heat transfer. The sides are closed to prevent horizontal draught influencing the measurements. A simple plastic sheet was used which could be easily removed and reattached when adjusting the depth of the air channel. Distances were all measured using tape measures with mm scales. A digital clinometer was used to ensure the layers were not tilted. Using this set-up it could be identified that the temperature could drop dramatically moving away from the PV-module either to the face or to the outer duct wall, by some 50 degrees. An air flow velocity was about 6 m/s close to the PV-module and some 1 m/s, for a given example. The PV-temperature (front and back) was lowest for a channel depth of 0.2 m, and higher for a 0.1 and 0.4 m channel, respectively. It has been found that the heat flow does not increase significantly for channel depth above 0.2 m, and further that also electricity generation reaches a plateau level for such a depth. For air flow channel depth of smaller than 0.1 m are typically insufficient. The PV-modules are preferably located in a middle of the channel, in view of heat flow and electricity generation. Also the PV-module us best located at about 0.1 m from the back (façade) wall in view thereof.

Table 1 gives some details. Therein it can be seen that the Air flow in four of the five examples is substantially constant, but the heat exchange is much better when a convective air flow is provided on both sides of the PV-module, and is optimum when the PV-module is substantially in the middle. A slight variation in energy conversion (efficiency) is found. Energy conversion is the best when the module is closest to the outside, and good when the module is on the wall.

TABLE 1

| Configuration | 1 | 2 | 3 | 4 | 5 |
|---|---|---|---|---|---|
| Air flow m3/h | 0.251 | 0.239 | 0.241 | 0.232 | 0 |
| Heat flow (MWh/y) | 3.250 | 4.380 | 4.410 | 4.410 | 0 |
| El. yield (MWh/y) | 1.290 | 1.120 | 1.120 | 1.120 | 1.27 |
| Total Yield (MWh/y) | 4.540 | 5.500 | 5.530 | 5.530 | 1.27 |

For ventilation purpose it is found that the supply is typically above a demand. A significant temperature change inside the building is achievable with the present module. Also, with the present module a significant energy reduction relative to a total demand of a building, is achievable.

The invention is further detailed by the accompanying figures, which are exemplary and explanatory of nature and are not limiting the scope of the invention. To the person skilled in the art it may be clear that many variants, being obvious or not, may be conceivable falling within the scope of protection, defined by the present claims.

### FIGURES

The invention although described in detailed explanatory context may be best understood in conjunction with the accompanying figures.

FIG. 1-3 show set-ups of the present invention.

FIGS. 4a-b show experimental results.

### DETAILED DESCRIPTION OF THE FIGURES

In the figures:

100 modular structure

1 PV-module

2 adaptable inlet

3 adaptable outlet

4 duct

4a outside wall duct

4b front duct air flow channel

4cback duct air flow channel

5 spacer

8 closure

9 heat absorber

11 opening

12 facade

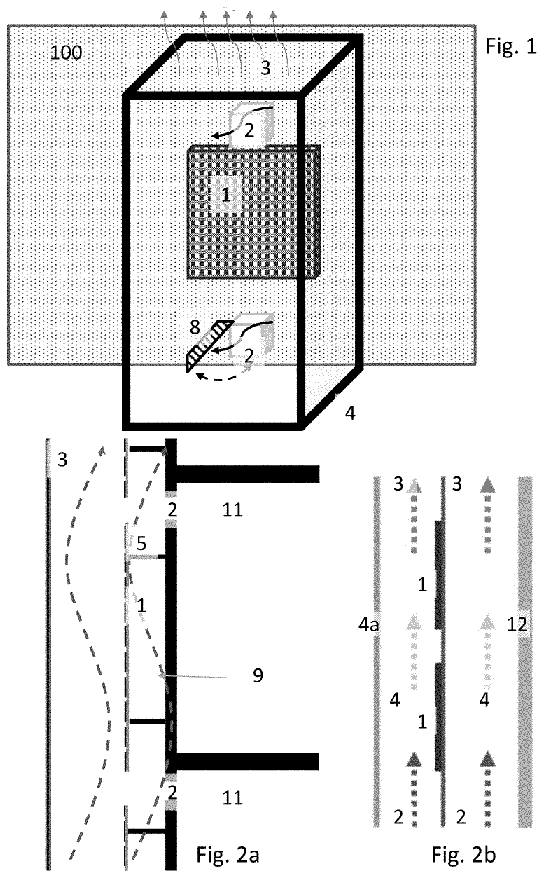

FIG. 1 schematically shows a duct 4 surrounding PV module 1, inlets 2, a closure 8, and outlet 3.

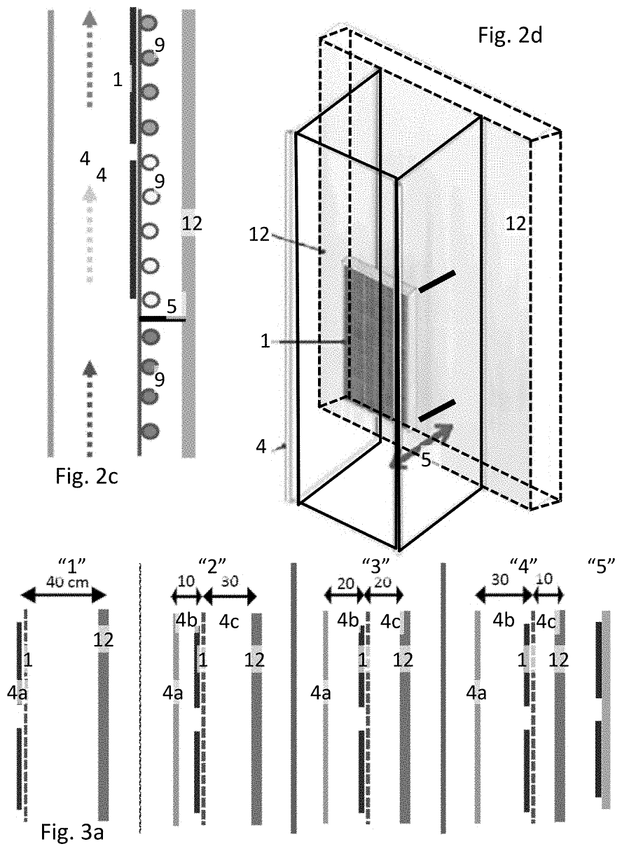

FIGS. 2a-d shows a side view, further showing openings 11 in the wall and heat absorber 9. In FIG. 2b an outer wall 4a (typically glass) of duct 4 is shown, with two air flows passing by PV-module 1. Also façade 12 is shown. FIG. 2c shows also cooling elements, in this case water pipes 9. Top water pipes are cooler than low water pipes. FIG. 2d shows a duct, attached to a (n existing) wall 11, wherein PV-module 1 is spaced apart from the wall by spacers 5, and spaced apart from the front side of the duct 4 by selecting the length of spacers 5.

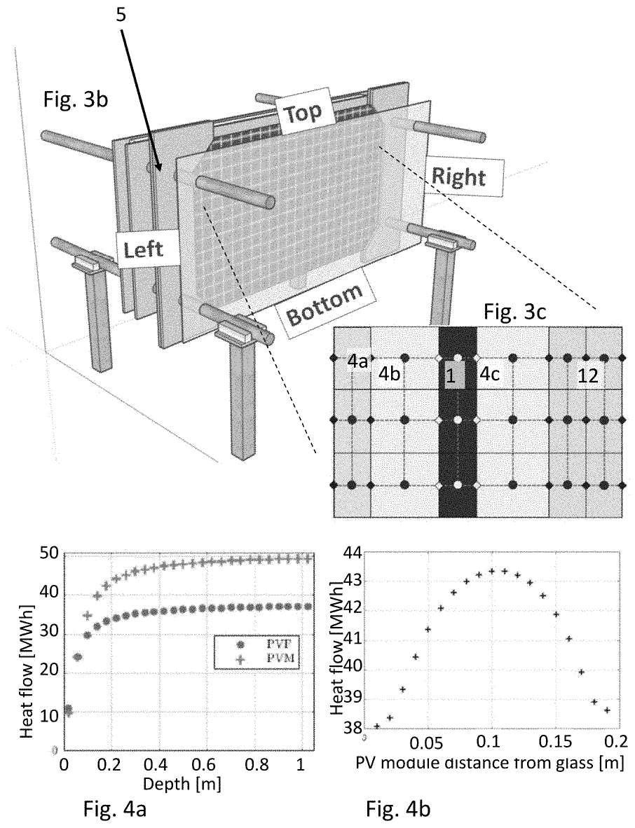

FIG. 3a shows four layouts (“1” to “5”) tested. “1” is a prior art layout, “2”-“4” layouts according to the invention with varying depth of air flow channels 4b and 4c respectively, and “5” is a layout of a PV-module directly mounted on a wall. The height of the chimney was 10 m, a width 1.2 m, a depth 0.4 m, and the chimney was oriented southward. FIG. 3b shows an experimental set-up showing a glazing, a PV-module, spacers, and a wall. FIG. 3c shows a thermal node model with the front glass part 4a of the duct, air flow channels 4b and 4c, PV module 1 and façade 12. Details of this experiment can be found in a paper entitled “Photovoltaic Chimney: Thermal modelling and concept demonstration for integration in Buildings” of Lizcano et al. A maximum width was determined by the size of the PV module which is 2 m. The width of the frame is an additional 0.1 m on both sides of the PV module resulting in a total width of the structure of 2.2 m. The height affects both the mass flow and the temperature distribution of the concept. Ideally, the height is as high as the façade of a building. The channel depth was varied between 0.1 m and 0.4 m in total, the aim of the experiment was to validate the model, and then use it to predict the best location for a PV module. Layer thicknesses were selected to be as close as possible to a real application. A glass-glass PV module of 8 mm thickness is used as front or middle layer. When the PV is placed in the middle, a hardened glass sheet of 8 mm thickness is used as front layer. Finally the back layer were MDF plates of 18 mm of thickness, insulated with 60 mm of thick polystyrene to simulate an insulating building material. The sides were closed with plastic sheets to prevent horizontal draught. Layers were placed as vertical as possible, and inclination readers were taken at each new set of data collection. 1000 W/m2 light was provided.

The environmental temperature was measured for different layout setups. It was found that there is a maximum difference of 6 K with a cavity depth of 0.1 m and the PVC layout located in the middle of a 0.48 m chimney cavity. A lower ambient temperature increases the difference in temperature with respect to the air within the cavity. This results on higher mass flow. However, this effect was found negligible compared to the effects of the cavity depth. With a PV-module located in the front, against the duct panel, the temperature difference was only a few K. A larger or smaller cavity depth than 0.1 m decrease the temperature effect significantly as well. Similar results were found for the relative humidity, varying between 25% for the best layout (0.1 m cavity depth) and 40% for the worst layout (PV-module in front). Also the temperature of the PV-module itself was measured and showed similar results as above. (about 20 K difference in temperature). Such large differences are rather unexpected. So a channel depth of 20 cm±5 cm was found the best, with the PV-modules located substantially in the middle thereof.

The highest flow velocity was obtained close to the PV module (about 3 m/s), dropping to close to zero in the right middle of the channel closest to the wall, and rising to about 0.5 m/s close to the wall, and close to the PV-module (about 6 m/s) at the side closer to the duct wall, dropping to about 1 m/2 in the left middle of the channel closest to the duct wall, and rising to about 7 m/s close to the duct wall, for a given case.

Heat flows for the present system were about 2-4 times as high (up to 5600 W/m, for the left channel) as prior art systems (about 1400 W/m), and again channels with a depth of about 20 cm with the PV-module in the middle performed best. Also mass flows were about 2 times better (about 0.25 kg/sm).

The PV-module temperature dropped from about 110° C. for a PV-module attached to the duct wall to about 85° C. for the present invention.

The performance of a PV-chimney was carried out by comparing it to the case of a PV-façade for a three story construction in Amsterdam, The Netherlands. The façade measurements, on both cases were assumed 10 m by 10 m, oriented towards South. A basic sensitivity analysis of the heat flow generation and electricity production was performed for both the PVF (front) and the PVC (channel) cases. The first step was to study the effect of the channel depth on both variables. The depth was varied from 0.2 m to 1.02 m in steps of 0.04 m. It was found that at smaller depths, heat flow generation changed significantly until it reached a plateau at 0.2 m. From this depth onward, the increase on heat flows grows slightly until a depth value of 0.4 m. The PVC, due to its configuration, presents a higher heat flow than the PVF. However, the PV modules on a PVC work at higher temperatures when compared to the PVF, which reduces their electrical performance. Experiments were performed with the aim to find the best position of the PV module inside the channel. As in the case of the cavity depth, both Heat flow and electricity production were studied. The modules were located from 0.01 m from the front glass to 0.01 m of the masonry wall with steps of 0.01 m. An optimum for heat flow production was found when the PV modules are located near the middle of the cavity, slightly closer to the front glass (FIG. 4a). To maximize electricity production, the middle of the cavity also yields the highest values, slightly closer to the masonry wall (FIG. 4b).

1. A modular structure for attaching to a wall comprising and enclosing at least one PV-module attached to at least one spacer, the spacer providing a distance of >5 cm of the back-side of the PV-module from the wall, the PV-module comprising an array of at least 2*2 cells, comprising at least one duct at least partly enclosing the at least one PV-module, the duct providing a distance of >5 cm of the front-side of the PV-module at least one adaptable inlet, wherein at least one inlet is located at the bottom part of the duct, at least one adaptable outlet located at the top part of the duct or in an outside of the duct, wherein the inlet and outlet are in fluid connection with at least one duct, wherein the vertical structure is adapted to provide a convective air flow over the front-side and over the back-side of the PV-module and through the duct and inlet and outlet, and a controller for opening and closing the at least one adaptable inlet and at least one adaptable outlet.

2. A structure according to claim 1, wherein the structure provides passive Heating, passive ventilation, and passive air conditioning (HVAC).

3. A structure according to claim 1, wherein the at least one inlet or at least one outlet comprise a closure.

4. A structure according to any of the preceding claim 1, wherein the at least one inlet is adapted to be in fluid contact with a at least one opening provided in a building wall.

5. A structure according to claim 1, wherein at least part of the vertical structure is.

6. A structure according to claim 1, wherein the at least one inlet or at least one outlet comprise a variable opening.

7. A structure according to claim 1, comprising at least one fastener for attaching to the wall of a building.

8. A structure according to claim 1, comprising a heat exchanger for stripping heat from the air flow, or a heat absorber, a phase change material, or a heat storage, or a combination thereof.

9. A structure according to claim 1, wherein a cross-sectional shape of the duct is selected from triangular, hexangular, square, rectangular, oval, circular, and combinations thereof.

10. A structure according to claim 1, wherein the duct is made of glass, an optical converter, a Fresnel lens, a gradient index lens, an axicon, a diffractive material, a parabolic concentrator, a reflector, and combinations.

11. A structure according to claim 1, wherein the PV-module comprises solar cells selected from interdigitated back contact solar cells, thin film solar cells, silicon based solar cells, Copper Indium Gallium Selenide thin film cells, and combinations thereof.

12. A structure according to claim 1, wherein the duct comprises an inlet at a base area thereof.

13. A structure according to claim 1, wherein the duct has a height of >1 m, a depth of >20 cm, and a width of >100 cm, and wherein the height:width is from 4:1 to 1:1.

14. A structure according to claim 1, wherein the convective air flow is a passive convective air flow.

15. A structure according to claim 1, wherein the at least one PV-module is located at >5 cm from a back from the structure.

16. A method of operating a modular vertical structure according to claim 1, comprising providing said vertical structure, converting light into electricity, providing a passive convective air flow over the PV-module and through the duct and inlet and outlet.

17. The method according to claim 16, wherein the vertical structure is provided below a roof line.
